(19) United States
(12) Patent Application Publication
(10) Pub. No.: US 2009/0287508 A1
(43) Pub. Date: Nov. 19, 2009

(54) METHODS OF ANALYSIS OF POLYMORPHISMS AND USES THEREOF

(75) Inventor: Robert Peter Young, Auckland (NZ)

Correspondence Address: DAVIS WRIGHT TREMAINE LLP - San Francisco, 505 MONTGOMERY STREET, SUITE 800, SAN FRANCISCO, CA, 94111, US

(73) Assignee: Synergenz Bioscience Limited, Tortola (VG)

(21) Appl. No.: 12/096,593

(22) PCT Filed: Dec. 7, 2006
(86) PCT No.: PCT/NZ06/00319

§ 371 Date: Dec. 19, 2008

(30) Foreign Application Priority Data
Dec. 7, 2005 (NZ) 544034

(51) Int. Cl. G06Q 40/00; G06F 19/00

(52) U.S. Cl. 705/4; 702/19

(57) ABSTRACT

The present invention provides methods for the assessment of a subject's health risk and the application of that assessment to a health-related decision, in particular a financial decision. The methods are dependant on the results of at least one genetic analysis, in particular genetic analyses that are predictive of predisposition to one or more diseases, including one or more genetic analyses of genetic polymorphisms associated with one or more diseases. Methods and systems for determining the availability of insurance to a subject utilising an assessment of a subject's health risk are also provided.

### FIELD OF THE INVENTION

The present invention relates to methods of assessing subject data (including genetic data) and deriving a Health Score for that subject indicative of predisposition to various diseases or conditions. That Health Score can be used in a variety of applications, inclusive in the making of financial decisions by, or in relation to, the subject. One such decision can be an insurance-related decision.

### BACKGROUND OF THE INVENTION

It has been estimated that over 4500 identified human diseases or conditions are due to genetic defects. Diseases with a direct genetic cause, such as, for example, sickle cell anemia, may be straightforward to diagnose or predict on the basis of genetic analysis. For example, the identification in the genome of a subject of an autosomal dominant genetic defect known to cause a disease means that that subject will, barring an intervening action, manifest that disease. Importantly, it is becoming increasingly apparent that a great proportion of diseases or conditions have a genetic component, whereby a subject's particular genetic makeup may for example render the subject more or less susceptible to a given disease or condition, or may ameliorate or exacerbate the symptoms of a disease or condition suffered by the subject. Often in such diseases the genetic component is multivariate, complex, and refractory to simple understanding. However, as our comprehension of the interrelationship between genetics and human health improves, our ability to predict disease susceptibility or severity on the basis of genetic analysis will likely also improve.

Clearly, the ability to predict susceptibility to one or more diseases or conditions is of great significance. Subjects, informed of their susceptibility to one or more diseases or conditions and whether found to be of greater or lesser susceptibility to a given disease, would be better able to determine an appropriate lifestyle and better able to manage their health. Health care providers would be better able to manage health care plans that could be targeted to the needs of individual subjects. Health insurance providers would be able to identify those subjects at high or low risk of suffering one or more diseases or conditions, and make appropriate decisions accordingly.

It would be desirable and advantageous to have methods to derive a Health Score for a subject reflective of their predisposition to one or more diseases or conditions, wherein the Health Score consists of or includes data generated by genetic analysis, and particularly where the Health Score is applied to a financial decision, including an insurance-related decision.

It is primarily to such methods of deriving a Health Score for a subject and the application of a Health Score to a financial decision that the present invention is directed.

### BRIEF DESCRIPTION OF THE INVENTION

In a first aspect the invention can be said to consist in a method of deriving a Health Score for a subject with respect to their predisposition to two or more diseases or conditions, at least one of which is selected from Chronic obstructive pulmonary disease (COPD), emphysema, Occupational chronic obstructive pulmonary disease (OCOPD), lung cancer or Acute coronary syndrome (ACS), said method comprising the steps of

receiving data predictive of the predisposition of said subject to at least two diseases or conditions, at least one of which is selected from COPD, emphysema, OCOPD, lung cancer and ACS, said data consisting of or including the result of at least one genetic analysis selected from the Emphagene™-brand pulmonary test (as herein defined), the Respirogene™-brand pulmonary test (as herein defined), the Bronchogene™-brand lung cancer test (as herein defined), the Cardiogene™-brand cardiovascular test (as herein defined) or the Combogene™-brand diagnostic test (as herein defined); and

determining a Health Score for said subject based upon that data.

As used herein “genetic analysis” means not only analysis directly at the nucleic acid level but also at the genetic-related analysis which may involve analysis of the level of expression and/or activity of a gene product, including on a proteomic basis.

Preferably, said disease or condition is selected from acquired diseases and conditions. “Acquired” diseases or conditions are those which develop, or to which a predisposition is developed, primarily due to lifestyle and occupational events. Diseases or conditions which result from smoking are one example of an acquired disease or condition.

Preferably, said data from said at least one genetic analysis is combined with data indicative of a predisposition on the part of said subject to one or more diseases or conditions based upon the family, occupational, environmental or lifestyle history of said subject.

Preferably, once derived, said Health Score is applied to a health-related decision, which can be a financial decision. Most preferably, that financial decision is an insurance-related decision.

In a further aspect, the invention provides a method of balancing a health risk and a financial risk with respect to a subject, said method comprising the steps of:

receiving data predictive of the predisposition of a subject to one or more diseases or conditions, said data consisting of or including the results of at least one genetic analysis;

determining a risk value for the subject based upon that data; and

factoring that risk value into a health-related decision to be made with respect to that subject.

Preferably, said health-related decision is a financial decision, which can be an insurance-related decision.

Preferably, said at least one genetic analysis is selected from amongst genetic tests which predict the predisposition of the subject to one or more diseases selected from cancer (including lung cancer), coronary artery disease (including ACS), COPD, emphysema and OCOPD.

Preferably, said tests are selected from the Emphagene™-brand pulmonary test (as herein defined), Respirogene™-brand pulmonary test (as herein defined), Bronchogene™-brand lung cancer test (as herein defined), Cardiogene™-brand cardiovascular test (as herein defined) and Combogene™-brand diagnostic test (as herein defined).

Preferably, said analysis or tests are targeted at predicting a predisposition to said disease or condition and an attendant risk value which is increased compared to other subjects of equivalent age, gender and history through detection of the presence of absence of one or more susceptibility polymorphisms (as herein defined).

Commonly, an increased risk value will be factored into an insurance-related decision selected from denial of insurance coverage to the subject and the offering of insurance coverage to said subject with benefits and premiums which reflect the increased risk value.

Alternatively, said tests are targeted at predicting a predisposition to said disease or condition and an attendant risk value which is reduced compared with other subjects of equivalent age, gender and history through detection of the presence or absence of one or more protective polymorphisms (as herein defined).

Commonly, a reduced risk value will be factored into an insurance-related decision selected from offering said subject an incentive to take out insurance coverage and offering insurance coverage with additional benefits, reduced premiums, or both.

Alternatively, said tests are targeted at predicting a predisposition to said disease or condition and an attendant risk value which is either increased or reduced compared with other subjects of equivalent age, gender and history through determination of a net single nucleotide polymorphism (SNP) score (as defined herein).

The subject can be an existing insured or a non-insured.

An existing insured can be a subject with exclusions to their insurance coverage for specific diseases or conditions and said additional benefits can be the offering of insurance coverage without said exclusions.

A non-insured can be a never insured.

A non-insured can also be a subject previously declined insurance and said additional benefits offered to such a subject with a reduced risk value can be the offering of insurance coverage.

In a further aspect, the invention provides a method of identifying a subject to be offered health insurance with respect to at least one disease or condition, said method comprising the steps of

receiving data predictive of the predisposition of a subject to one or more diseases or conditions, said data consisting of or including the result of at least one genetic analysis which shows the presence of at least one protective polymorphism with respect to at least one disease or condition; and

offering said subject health insurance with coverage of said at least one disease or condition.

Preferably, said data consists of or includes the result of one or more of the Emphagene™-brand pulmonary test (as herein defined), Respirogene™-brand pulmonary test (as herein defined), Bronchogene™-brand lung cancer test (as herein defined), Cardiogene™-brand cardiovascular test (as herein defined) and Combogene™-brand diagnostic test (as herein defined).

The subject can be an existing insured, or can be a non-insured.

A non-insured can be a never insured, or can be a subject previously declined insurance with respect to said at least one disease or condition.

An existing insured can also be a subject with an insurance policy from which coverage of said at least one disease or condition is excluded.

Preferably, said subject is an existing insured and said offer of insurance includes incentives to persuade said subject to replace their existing insurance policy with the newly offered insurance policy.

In this embodiment, the incentives are selected from a cash payment, a prize, additional insurance benefits and reduced premiums, or any of combination of those.

Preferably, said subject is an existing insured who is insured by the offerer of the insurance.

Alternatively, said subject is an existing insured who is not insured by the offerer of the insurance.

In a further aspect, the invention provides a method of identifying a subject to be offered health insurance with respect to at least one disease or condition, said method comprising the steps of:

receiving data predictive of the predisposition of a subject to one or more diseases or conditions,

said data consisting of or including the result of at least one genetic analysis which shows the presence of a net protective score (as herein defined) for the subject with respect to at least one disease or condition; and

offering said subject health insurance with coverage of said at least one disease or condition.

In still a further aspect, the invention provides a method of marketing an insurance product with coverage of at least one disease or condition to a subject, said method comprising the step of:

offering said subject an incentive to buy said product, said incentive being receivable by said subject upon the insurance offerer being provided with the result of at least one genetic analysis which shows the presence in said subject of at least one protective polymorphism with respect to said at least one disease or condition.

Preferably, in said method said insurance offerer arranges for and/or bears the cost of said subject undertaking said at least one genetic analysis.

Preferably, said incentive is or includes a cash payment.

Alternatively, said incentive is or includes a prize.

In one embodiment, said subject is an existing insured and said incentive is or includes the provision to said subject of an insurance policy with benefits additional to their existing insurance policy, insurance policy with the same coverage as their existing policy but at a reduced premium or an insurance policy with a mix of coverage, benefits and premiums which the subject considers to be to their advantage.

In one embodiment, said subject is an existing insured who is insured by the offerer of the insurance product.

Alternatively, said subject is an existing insured who is not insured by the offerer of the insurance product.

In still a further aspect, the invention provides a method of marketing an insurance product with coverage of at least one disease or condition to a subject, said method comprising the step of:

offering said subject an incentive to buy said product, said incentive being receivable by said subject upon the insurance offerer being provided with the result of at least one genetic analysis which shows the presence of a net protective score (as herein defined) for the subject with respect to said at least one disease or condition.

In yet a further aspect, the invention provides a method of identifying, for the commercial benefit of an insurance provider, a subject as having an advantageous insurance risk profile with respect to at least one disease or condition, comprising the steps of:

receiving data predictive of the predisposition of a subject to one or more diseases or conditions, said data consisting of or including the result of at least one genetic analysis; and

identifying said subject as having an advantageous risk profile where said analysis shows the presence of at least one protective polymorphism with respect to at least one disease or condition.

Preferably, said data consists of or includes the result of one or more of the Emphagene™-brand pulmonary test (as herein defined), Respirogene™-brand pulmonary test (as herein defined), Bronchogene™-brand lung cancer test (as herein defined), Cardiogene™-brand cardiovascular test (as herein defined) and Combogene™-brand diagnostic test (as herein defined).

Preferably, said method is performed simultaneously or sequentially with respect to a number of subjects and those subjects identified as having an advantageous insurance risk profile are grouped.

Preferably, said grouped subjects are offered insurance.

In yet a further aspect, the invention provides a method of identifying, for the commercial benefit of an insurance provider, a subject as having an advantageous insurance risk profile with respect to at least one disease or condition, comprising the steps of:

receiving data predictive of the predisposition of a subject to one or more diseases or conditions, said data consisting of or including the result of at least one genetic analysis; and

identifying said subject as having an advantageous risk profile where said analysis shows the presence of a net protective score (as herein defined) for the subject with respect to at least one disease or condition.

In a further aspect, the invention provides an insurance product to be marketed to at least one subject by an offerer, said product comprising or including:

an incentive component; and

a coverage component;

wherein the availability of at least the incentive component to the subject is conditioned upon the provision to the offerer of the results of at least one genetic analysis predictive of the predisposition of said subject to one or more diseases or conditions.

Preferably, said at least one genetic analysis is selected from the Emphagene™-brand pulmonary test, Respirogene™-brand pulmonary test, Bronchogene™-brand lung cancer test, Cardiogene™-brand cardiovascular test and Combogene™-brand diagnostic test.

Preferably, the availability of the coverage component is also conditioned upon the results of the genetic analysis or analyses being acceptable to said offerer.

In this embodiment, a result acceptable to said offerer is the presence in said subject of at least one protective polymorphism with respect to at least one disease or condition, with the effect that a coverage component which covers the subject for that at least one disease or condition is made available to said subject.

In another embodiment, a result acceptable to said offerer is the presence of a net protective score for said subject with respect to at least one disease or condition, with the effect that a coverage component which covers the subject for that at least one disease or condition is made available to said subject.

The incentive can be a cash payment or a prize.

The incentive can also be the availability of coverage with a benefit/premium mix which the subject considers to be to their advantage.

Still further, the incentive can be or can include the offerer bearing the cost of said genetic analysis or analyses.

In another embodiment, upon provision of the results of the genetic analysis or analyses, a coverage component is always available to said subject.

Coverage can be offered on a disease or condition specific basis, or on a general health basis.

The subject can be an existing insured who is insured by the offerer of the insurance.

Alternatively, the subject can be an existing insured who is not insured by the offerer of the insurance.

In still a further aspect, the invention provides a system for determining the availability, or the terms and conditions of availability, of health insurance to a subject with respect to at least one disease or condition, said system comprising:

computer processor means for receiving, processing and communicating data;

storage means for storing data including a reference genetic database of the results of genetic analysis with respect to at least one disease or condition and a reference insurance database of prices, terms and conditions upon which insurance can be made available with respect to said at least one disease or condition; and

a computer program embedded within the computer processor which, once data consisting of or including the result of a genetic analysis for which data is included in the reference genetic database is received, processes said data in the context of said reference databases to determine, as an outcome, whether said insurance should be available and, if so, at what price and on what terms and conditions, said outcome being communicable once known to a user having input said data.

In one embodiment, the data is input by a representative of an insurance provider.

In another embodiment, the data is input by a subject seeking insurance, their medical advisor or other representative.

Preferably, said system is accessible via the internet or by personal computer.

Preferably, said reference genetic database comprises or includes the results of a disease-associated genetic analysis selected from one or more of the Emphagene™-brand pulmonary test, Resipirogene, Bronchogene™-brand lung cancer test, Cardiogene™-brand cardiovascular test and Combogene™-brand diagnostic test.

More preferably, said reference genetic database comprises or includes the results of all of the Emphagene™-brand pulmonary test, Respirogene™-brand pulmonary test, Bronchogene™-brand lung cancer test, Cardiogene™-brand cardiovascular test and Combogene™-brand diagnostic test.

In yet a further aspect, the invention provides a computer program suitable for use in a system as defined above comprising a computer usable medium having program code embodied in the medium for causing the computer program to process received data consisting of or including the result of at least one disease-associated genetic analysis in the context of both a reference genetic database of the results of said at least one disease-associated genetic analysis and a reference insurance database of prices, terms and conditions upon which insurance with respect to said at least one disease-associated genetic analysis can be made available.

Preferably, the at least one disease-associated genetic analysis is selected from the Emphagene™-brand pulmonary test, Respirogene™-brand pulmonary test, Bronchogene™-brand lung cancer test, Cardiogene™-brand cardiovascular test and Combogene™-brand diagnostic test.

In a still further aspect, the invention provides for the use of data predictive of the predisposition of a subject to at least two diseases or conditions, at least one of which is selected from Chronic obstructive pulmonary disease (COPD), emphysema, Occupational chronic obstructive pulmonary disease (OCOPD), lung cancer or Acute coronary syndrome (ACS), in the derivation of a Health Score for the subject,

said data consisting of or including the result of at least one genetic analysis selected from the Emphagene™-brand pulmonary test (as herein defined), the Respirogene™-brand pulmonary test (as herein defined), the Bronchogene™-brand lung cancer test (as herein defined), the Cardiogene™-brand cardiovascular test (as herein defined) or the Combogene™-brand diagnostic test (as herein defined),

and said Health Score being representative of the subject's predisposition to the two or more diseases or conditions.

Preferably, the use is to derive a Health Score to be applied to a financial decision, more preferably the financial decision is an insurance-related decision.

In a still further aspect, the invention provides for the use of data predictive of the predisposition of a subject to one or more diseases or conditions in determining a risk value for the subject based upon that data,

said data consisting of or including the results of at least one genetic analysis which shows the presence of at least one protective polymorphism with respect to at least one disease or condition;

wherein the risk value is factored into a health-related decision to be made with respect to that subject.

Preferably, said health-related decision is a financial decision, more preferably the financial decision is an insurance-related decision.

In a still further aspect, the invention provides for the use of data predictive of the predisposition of a subject to one or more diseases or conditions in determining a risk value for the subject based upon that data,

said data consisting of or including the results of at least one genetic analysis which shows the presence of a net protective score (as herein defined) for the subject with respect to at least one disease or condition;

wherein the risk value is factored into a health-related decision to be made with respect to that subject.

In a further aspect, the invention provides for the use of data predictive of the predisposition of a subject to one or more diseases or conditions in the identification of a subject to be offered health insurance with respect to at least one disease or condition,

said data consisting of or including the results of at least one genetic analysis which shows the presence of at least one protective polymorphism with respect to at least one disease or condition.

In yet a further aspect, the invention provides for the use of data predictive of the predisposition of a subject to one or more diseases or conditions in the identification of a subject to be offered health insurance with respect to at least one disease or condition,

said data consisting of or including the results of at least one genetic analysis which shows the presence of a net protective score for the subject with respect to at least one disease or condition.

### BRIEF DESCRIPTION OF FIGURES

FIG. 1 depicts a graph showing a distribution of combined scores for SNP tests for lung cancer, acute coronary syndrome and COPD amongst smokers as described in Example 5 herein.

### DESCRIPTION OF PREFERRED EMBODIMENTS

The invention has a number of related aspects.

In a first aspect, the methods of the invention enable the derivation of a Health Score for a subject, wherein the Health Score relates to the subject's predisposition to a range of (two or more) diseases or conditions, at least one of which is selected from COPD, emphysema, OCOPD, lung cancer and ACS. The Health Score is determined at least in part with regard to the result of at least one genetic analysis selected from the Emphagene™-brand pulmonary test, Respirogene™-brand pulmonary test, Bronchogene™-brand lung cancer test, Cardiogene™-brand cardiovascular test and Combogene™-brand diagnostic test, each as defined herein.

As used herein, the Emphagene™-brand pulmonary test comprises the methods of determining a subject's predisposition to and/or potential risk of developing chronic obstructive pulmonary disease (COPD) and/or emphysema and related methods as defined in New Zealand Patent Applications No. 539934, No. 541935, No. 545283, and PCT International Application PCT/NZ2006/000103 (published as WO2006/121351) each incorporated herein in its entirety.

In particular, the Emphagene™-brand pulmonary test includes a method of determining a subject's risk of developing one or more obstructive lung diseases comprising analysing a sample from said subject for the presence or absence of one or more polymorphisms selected from the group consisting of:
−765 C/G in the promoter of the gene encoding Cyclooxygenase 2 (COX2);
105 C/A in the gene encoding Interleukin18 (IL18);
−133 G/C in the promoter of the gene encoding IL18;
−675 4G/5G in the promoter of the gene encoding Plasminogen Activator Inhibitor 1 (PAI-1);
874 A/T in the gene encoding Interferon-γ−(IFN-γ);
+489 G/A in the gene encoding Tissue Necrosis Factor α (TNFα);
C89Y A/G in the gene encoding SMAD3;
E 469 K A/G in the gene encoding Intracellular Adhesion molecule 1 (ICAM1);
Gly 881Arg G/C in the gene encoding Caspase (NOD2);
161 G/A in the gene encoding Mannose binding lectin 2 (MBL2);
−1903 G/A in the gene encoding Chymase 1 (CMA1);
Arg 197 Gln G/A in the gene encoding N-Acetyl transferase 2 (NAT2);
−366 G/A in the gene encoding 5 Lipo-oxygenase (ALOX5);
HOM T2437C in the gene encoding Heat Shock Protein 70 (HSP 70);
+13924 T/A in the gene encoding Chloride Channel Calcium-activated 1 (CLCA1);
−159 C/T in the gene encoding Monocyte differentiation antigen CD-14 (CD-14); exon 1 +49 C/T in the gene encoding Elafin; or
−1607 1G/2G in the promoter of the gene encoding Matrix Metalloproteinase 1 (MMP1), with reference to the 1G allele only;

wherein the presence or absence of one or more of said polymorphisms is indicative of the subject's risk of developing one or more obstructive lung diseases selected from the group consisting of chronic obstructive pulmonary disease (COPD), emphysema, or both COPD, emphysema, or both COPD and emphysema.

The one or more polymorphisms can be detected directly or by detection of one or more polymorphisms which are in linkage disequilibrium with said one or more polymorphisms.

Linkage disequilibrium (LD) is a phenomenon in genetics whereby two or more mutations or polymorphisms are in such close genetic proximity that they are co-inherited. This means that in genotyping, detection of one polymorphism as present infers the presence of the other. (Reich D E et al; Linkage disequilibrium in the human genome, Nature 2001, 411:199-204.)

As used herein, the Bronchogene™-brand lung cancer test comprises the methods of determining a subject's predisposition to and/or potential risk of developing lung cancer and related methods as defined in New Zealand Patent Application Nos 540203, No. 541787, No. 543297, No. 550643, and PCT International Application PCT/NZ2006/000125 (published as WO2006/123955) each incorporated herein in their entirety.

In particular, the Bronchogene™-brand lung cancer test includes a method of determining a subject's risk of developing lung cancer comprising analysing a sample from said subject for the presence or absence of one or more polymorphisms selected from the group consisting of:
Asp 298 Glu in the gene encoding Nitric oxide synthase 3 (NOS3);
−786 T/C in the promoter of the gene encoding NOS3;
Arg 312 Gln in the gene encoding Superoxide dismutase 3 (SOD3);
Ala 15 Thr in the gene encoding Anti-chymotrypsin (ACT);
Asn 357 Ser A/G in the gene encoding Matrix metalloproteinase 12 (MMP12);
105 A/C in the gene encoding Interleukin-18 (IL-18);
−133 G/C in the promoter of the gene encoding Interleukin-18;
874 A/T in the gene encoding Interferon γ (IFNγ);
−765 G/C in the gene encoding Cyclooxygenase 2 (COX2);
−447 G/C in the gene encoding Connective tissue growth factor (CTGF);
−221 C/T in the gene encoding Mucin 5AC (MUC5AC);
+161 G/A in the gene encoding Mannose binding lectin 2 (MBL2);
intron 1 C/T in the gene encoding Arginase 1 (Arg1);
Leu 252 Val C/G in the gene encoding Insulin-like growth factor II receptor (IGF2R); or
−1082 A/G in the gene encoding Interleukin 10 (IL-10);

wherein the presence or absence of one or more of said polymorphisms is indicative of the subject's risk of developing lung cancer.

Again, the one or more polymorphisms can be detected directly or by detection of one or more polymorphisms which are in linkage disequilibrium with said one or more polymorphisms.

As used herein, the Respirogene™-brand pulmonary test comprises the methods of determining a subject's predisposition to and/or potential risk of developing occupational chronic obstructive pulmonary disease (OCOPD) and related methods as defined in New Zealand Patent Applications No. 540202, No. 541389, and PCT International Application PCT/NZ2006/000124 (published as WO2006/123954) each incorporated herein in their entirety.

In particular, the Respirogene™-brand pulmonary test includes a method of determining a subject's risk of developing occupational chronic obstructive pulmonary disease comprising analysing a sample from said subject for the presence or absence of one or more polymorphisms selected from the group consisting of:
−765 C/G in the promoter of the gene encoding cyclooxygenase 2 (COX2);
Ile 105 Val (A/G) in the gene encoding glutathione S transferase P (GSTP1);
105 C/A in the gene encoding interleukin-18 (IL-18);
−133 G/C in the promoter of the gene encoding IL-18;
−251 A/T in the gene encoding interleukin-8 (IL-8);
Lys 420 Thr (A/C) in the gene encoding Vitamin D binding protein (VDBP);
Glu 416 Asp (T/G) in the gene encoding VDBP;
exon 3 T/C (R/r) in the gene encoding microsomal epoxide hydrolase (MEH);
Arg 312 Gln (AC) in the gene encoding superoxide dismutase 3 (SOD3);
3′ 1237 G/A (T/t) in the gene encoding α1-antitrypsin;
α1-antitrypsin (α1AT) S polymorphism;
Asp 299 Gly A/G in the gene encoding toll-like receptor 4 (TLR4);
Gln27Glu in the gene encoding β2 adrenoreceptor (ADRB2);
−518 G/A in the promoter of the gene encoding interleukin-11 (IL-11);
−1055 (C/T) in the promoter of the gene encoding interleukin-13 (IL-13);
−675 4G/5G in the promoter of the gene encoding plasminogen activator inhibitor 1 (PAI-1);
298 Asp/Glu (T/G) in the gene encoding nitric oxide synthase 3 (NOS3);
−1607 1G/2G in the gene encoding matrix metalloproteinase 1 (MMP1);

wherein the presence or absence of one or more of said polymorphisms is indicative of the subject's risk of developing occupational chronic obstructive pulmonary disease.

Again, the one or more polymorphisms can be detected directly or by detection of one or more polymorphisms which are in linkage disequilibrium with said one or more polymorphisms.

As used herein, the Cardiogene™-brand cardiovascular test comprises the methods of determining a subject's predisposition to and/or potential risk of developing acute coronary syndrome (ACS) and related methods as defined in New Zealand Patent Application No. 543520, No. 543985, No. 549951, and PCT International Application PCT/NZ2006/000292 each incorporated herein in their entirety.

In particular, the Cardiogene™-brand cardiovascular test includes a method of determining a subject's risk of developing ACS comprising analysing a sample from said subject for the presence or absence of one or more polymorphisms selected from the group consisting of:
−1903 A/G in the gene encoding Chymase 1 (CMA1);
−82 A/G in the gene encoding Matrix metalloproteinase 12 (MMP12);
Ser52Ser (223 C/T) in the gene encoding Fibroblast growth factor 2 (FGF2);
Q576R A/G in the gene encoding Interleukin 4 receptor alpha (IL4RA);
HOM T2437C in the gene encoding Heat Shock Protein 70 (HSP 70);
874 A/T in the gene encoding Interferon γ (IFNG);
−589 C/T in the gene encoding Interleukin 4 (IL-4);
−1084 A/G (−1082) in the gene encoding Interleukin 10 (IL-10);
Arg213Gly C/G in the gene encoding Superoxide dismutase 3 (SOD3);
459 C/T Intron I in the gene encoding Macrophage inflammatory protein 1 alpha (MIP1A);
Asn 125 Ser A/G in the gene encoding Cathepsin G;
1249V C/T in the gene encoding Chemokine (CX3C motif) receptor 1 (CX3CR1);
Gly 881 Arg G/C in the gene encoding Caspase (NOD2); or
372 T/C in the gene encoding Tissue inhibitor of metalloproteinase 1 (TIMP1);

wherein the presence or absence of one or more of said polymorphisms is indicative of the subject's risk of developing ACS.

The one or more polymorphisms can be detected directly or by detection of one or more polymorphisms which are in linkage disequilibrium with said one or more polymorphisms.

As used herein, the Combogene™-brand diagnostic test comprises the methods of assessing the susceptibility of a subject to a disease and related methods as defined in New Zealand Patent Applications No. 540249, No. 541842, No. 551534, and PCT International Application PCT/NZ2006/000104 (published as WO2006/123943) each incorporated herein in their entirety.

In particular, the Combogene™-brand diagnostic test includes a method of assessing a subject's risk of developing a disease which comprises:

analysing a biological sample from said subject for the presence or absence of protective polymorphisms and for the presence or absence of susceptibility polymorphisms, wherein said protective and susceptibility polymorphisms are associated with said disease;

assigning a positive score for each protective polymorphism and a negative score for each susceptibility polymorphism or vice versa;

calculating a net score for said subject, said net score representing the balance between the combined value of the protective polymorphisms and the combined value of the susceptibility polymorphisms present in the subject sample;

wherein a net protective score is predictive of a reduced risk of developing said disease and a net susceptibility score is predictive of an increased risk of developing said disease.

The value assigned to each protective polymorphism may be the same or may be different. The value assigned to each susceptibility polymorphism may be the same or may be different, with either each protective polymorphism having a negative value and each susceptibility polymorphism having a positive value, or vice versa.

Furthermore, the Combogene™-brand diagnostic test includes a method of determining a subject's risk of developing a disease, said method comprising obtaining the result of one or more analyses of a sample from said subject to determine the presence or absence of protective polymorphisms and the presence or absence of susceptibility polymorphisms, and wherein said protective and susceptibility polymorphisms are associated with said disease;

assigning a positive score for each protective polymorphism and a negative score for each susceptibility polymorphism or vice versa;

calculating a net score for said subject, said net score representing the balance between the combined value of the protective polymorphisms and the combined value of the susceptibility polymorphisms present in the subject sample;

wherein a net protective score is predictive of a reduced risk of developing said disease and a net susceptibility score is predictive of an increased risk of developing said disease.

In the case of each of the Emphagene™-brand pulmonary test, Bronchogene™-brand lung cancer test, Respirogene™-brand pulmonary test, Cardiogene™-brand cardiovascular test and Combogene™-brand diagnostic test, the “result” will normally be a categorisation of the genetic test outcome as indicative of the subject having a predisposition to the disease or condition which is greater than average (an increased predisposition), average (a neutral predisposition) or less than average (a reduced predisposition). Commonly, the categorisation will be made following a comparison of the raw data with a reference genetic database made up of data from a statistically-relevant number of similar tests performed previously and for which the association between specific genetic sequences and the presence or absence of disease is known. In preferred embodiments, the database will include specific polymorphic information, with individual polymorphisms being associated with either an increased predisposition to a disease or to a reduced predisposition to a disease. In alternative embodiments, the categorisation will be a determination of whether a net score for the subject lies within a threshold on a distribution of net scores determined for disease sufferers and non-sufferers, said threshold separating individuals having an increased predisposition from those individuals having a decreased predisposition.

The Health Score can be based upon the combined results of two or more of the Emphagene™-brand pulmonary test, Respirogene™-brand pulmonary test, Bronchogene™-brand lung cancer test, Cardiogene™-brand cardiovascular test and Combogene™-brand diagnostic test. However, in other embodiments one or more of the Emphagene™-brand pulmonary test, Respirogene™-brand pulmonary test, Bronchogene™-brand lung cancer test, Cardiogene™-brand cardiovascular test and Combogene™-brand diagnostic test can also be combined with other genetic analyses indicative of a susceptibility to disease, including those identified on the Online Mendelian Inheritance in Man (OMIM) Morbid Map at www.ncbi.nlm.nih.gov/Omim/getmorbid.cgi (incorporated herein in its entirety). For example, genetic analyses indicative of a susceptibility to breast cancer, including genetic analyses of polymorphisms in the BRCA1 gene (see, for example, www.ncbi.nlm.nih.gov/entrez/dispomim.cgi?id=113705, incorporated herein in its entirety, and in particular the selected allelic variants described therein), genetic analyses of polymorphisms in the BRCA2 gene (see, for example, www.ncbi.nlm.nih.gov/entrez/dispomim.cgi?cmd=entry&id=600185, incorporated herein in its entirety, and in particular the selected allelic variants described therein), and genetic analyses of polymorphisms in the BRCA3 gene (see, for example, www.ncbi.nlm.nih.gov/entrez/dispomim.cgi?id=605365, incorporated herein in its entirety); and genetic analyses indicative of a susceptibility to Wilm's tumour, including for example, genetic analyses of polymorphisms in the WT1 gene (see, for example, www.ncbi.nlm.nih.gov/entrez/dispomim.cgi?id=607102, incorporated herein in its entirety, and in particular the selected allelic variants described therein), may be combined with one of more of the Emphagene™-brand pulmonary test, Respirogene™-brand pulmonary test, Bronchogene™-brand lung cancer test, Cardiogene™-brand cardiovascular test and Combogene™-brand diagnostic test.

Data comprising the results of the genetic analysis (or analyses) performed as above, can also be used to derive the Health Score for any subject in combination with other risk factor and/or health criteria. In particular, the derivation of the Health Score may additionally have regard to risk factors and/or biometric or biomedical parameters, including but not limited to age, sex, familial history, smoking, alcohol consumption, diet, exercise, blood pressure, body weight, body-mass-index, body fat, serum cholesterol and triglyceride levels or ratios including total cholesterol level, high density cholesterol level, ratio of total cholesterol level to high density cholesterol level, low density cholesterol level, hemoglobin A1c score, glucose level, gamma glutamyltransferase level, and other health risk factors.

Further examples of biomedical parameters used to determine a Health Score assess vital organ function, including, for example, serum concentration of at least one of glucose, blood urea nitrogen, creatinine, uric acid, bilirubin, serum glutamic-oxaloacetic transaminase enzyme, serum glutamate pyruvate transaminase enzyme, alkaline phosphatase, lactic acid dehydrogenase, total protein, albumin, globulin, iron, calcium, phosphorous, sodium, potassium, chloride, high density lipoprotein, triglycerides, total cholesterol, very low density lipoprotein, and/or low density lipoprotein. Therapeutic ratios can also be calculated, including, for example, albumin/globulin ratio, total cholesterol/high density lipoprotein ratio, and/or low density lipoprotein/high density lipoprotein ratio.

Further, a health risk factor and/or biometric or biomedical parameter can be evaluated in comparison to a medical index of normal range to assist in determining the Health Score.

Once determined, the Health Score can be applied to any health-related decision, which can be a financial decision taken by or for the subject by a health-service provider, which can in turn be a health insurer.

Therefore, in one embodiment, the invention has particular application to the health insurance industry. Health insurers use a number of criteria, including but not limited to familial, biometric, physiological, and environmental criteria and/or risk factors, when assessing the nature of any insurance to be offered to a given subject. Clearly, a subject with no manifest known risk factors for one or more diseases or conditions presents a more desirable insuree than a subject with a great number of known risk factors for a number of diseases or conditions. Conversely, a subject may present with a number of identifiable risk factors for a given disease and so be regarded as a high-risk insuree. However, in each case the subject's genetic makeup may render them more or less susceptible to a given disease. For example, the subject with no manifest risk factors for a given disease may be genetically predisposed to that disease. Similarly, the ostensibly high-risk subject with a number of manifest risk factors may, because of their particular genetic makeup, be resistant to said disease and thus a much lower risk and consequently a desirable insuree. This embodiment of the present invention therefore recognises the advantage in assessing data relating to a subject's genetic predisposition to or resistance to developing one or more diseases or conditions, and applying such data when making financial decisions, particularly insurance-related decisions.

In another embodiment, the invention provides a method of balancing a health risk and a financial risk with respect to a subject. The first step of the method is to receive data predictive of the predisposition of a subject to one or more diseases or conditions, the data consisting of or including the results of at least one genetic analysis conducted with respect to the diseases or conditions in question.

As discussed above, an increasing number of diseases or conditions are believed to have a genetic component. This may be associated with disease onset, duration, severity, recurrence, and the like. As our understanding of the etiology of a given disease or condition improves, it is likely more and more markers associated with predisposition to that disease or condition will be found. Any disease or condition in which a genetic marker such as a polymorphism can be associated with decreased predisposition (herein “a protective polymorphism”) and/or increased predisposition (herein “a susceptibility polymorphism”) to the disease or condition is amenable to use in the methods of the present invention.

Examples of such diseases which are particularly relevant to the present invention, are given below.

Chronic Obstructive Pulmonary Disease

Chronic obstructive pulmonary disease (COPD) is the 4^{th} leading cause of death in developed countries and a major cause for hospital readmission world-wide. It is characterised by insidious inflammation and progressive lung destruction. It becomes clinically evident after exertional breathlessness is noted by affected smokers when 50% or more of lung function has already been irreversibly lost. This loss of lung function is detected clinically by reduced expiratory flow rates (specifically forced expiratory volume in one second or FEV1). Over 95% of COPD is attributed to cigarette smoking yet only 20% or so of smokers develop COPD (herein termed susceptible smokers). Studies surprisingly show that smoking dose accounts for only about 16% of the impaired lung function.

COPD is a heterogeneous disease encompassing, to varying degrees, emphysema and chronic bronchitis which develop as part of a remodelling process following the inflammatory insult from chronic tobacco smoke exposure and other air pollutants. A number of family studies comparing concordance in siblings (twins and non-twin) consistently show a strong familial tendency. It is likely that many genes are involved in the development of COPD.

Despite advances in the treatment of airways disease, current therapies do not significantly alter the natural history of COPD with progressive loss of lung function causing respiratory failure and death. Although cessation of smoking has been shown to reduce this decline in lung function if this is not achieved within the first 20 years or so of smoking for susceptible smokers, the loss is considerable and symptoms of worsening breathlessness cannot be averted. A number of epidemiology studies have consistently shown that at exposure doses of 20 or more pack years, the distribution in lung function tends toward trimodality with a proportion of smokers maintaining normal lung function (resistant smokers) even after 60+ pack years, a proportion showing modest reductions in lung function who may never develop symptoms and a proportion who show an accelerated loss in lung function who invariably develop COPD. This suggests that amongst smokers 3 populations exist, those resistant to developing COPD, those at modest risk and those at higher risk (termed susceptible smokers).

Therefore, when considering a financial decision relating to the health of a subject, particularly an insurance-related decision, it would be advantageous to be able to identify resistant smokers, those at moderate risk, and those smokers who are most susceptible to developing COPD. For example, it would be advantageous to be able to determine if a given subject was resistant to, at moderate risk of, or susceptible to developing COPD, and in one particularly preferred example, if a smoker previously believed to be susceptible to COPD is determined to be resistant to developing COPD.

Methods to determine a subject's predisposition to and/or potential risk of developing chronic obstructive pulmonary disease (COPD) and/or emphysema are described in New Zealand Patent Application No. 539934, No. 541935, No. 545283, and PCT International Application PCT/NZ2006/000103 (published as WO2006/121351) each incorporated herein in its entirety, and are referred to collectively herein as the Emphagene™-brand pulmonary test test. Both protective polymorphisms and susceptibility polymorphisms have been identified for analysis as part of the Emphagene™-brand pulmonary test test.

Occupational Chronic Obstructive Pulmonary Disease

Occupational chronic obstructive pulmonary disease (OCOPD) is a well-recognized and well-studied consequence of chronic exposure to a diverse range or aero-pollutants in the workplace. A recent document published by the American Thoracic Society on the occupational contribution to COPD estimates that 15% of all COPD is work related with annual costs of US$7 billion [see 1]. OCOPD is ranked the second highest cause of occupationally related death and believed to be on the rise.

Both cross sectional and prospective studies have shown that OCOPD occurs in a range of occupations characterized by chronic exposure to dust and/or other aero-pollutants including organic and inorganic aero-pollutants. These occupations and industries include metallurgy, iron and steel workers, wood processing workers, chemistry and chemical workers, pulp and paper manufacturing, printing industry, farmers, armed forces, flour milling, popcorn manufacturing, coal, gold, silica and rock miners, welders, painters, boat builders, cotton/synthetic textile workers, construction workers, tobacco workers, and ammonia workers. Examples of pollutants associated with OCOPD include heavy metals (including Cadmium and Vanadium), Nitrogen dioxide, Sulphur dioxide, grain dust, endotoxin, solvents and resins.

In two separate studies, it is estimated that around 40 million people in the United States work force are employed in the “at risk” occupations listed above [see 2, 3].

Studies show that OCOPD results from host factors (including genetic makeup) in combination with exposure dose (for example, concentration and duration). It has been estimated that about 20% of those workers in these occupations may be susceptible to OCOPD.

Importantly, the link between the above occupations and risk of OCOPD is independent of the effects of smoking, ethnicity, and age. In nonsmokers it has been shown that the effect from repeated exposure to the dusts or fumes from the above occupations is equivalent to the effect of smoking in inducing COPD. Moreover, for smokers the combined effect of their smoking and occupational exposure on decline in lung function is greater than either one alone. Therefore, smokers who are also exposed to aero-pollutants at work are at significant risk.

OCOPD is characterised by insidious inflammation and progressive lung destruction. It becomes clinically evident after exertional breathlessness is noted by affected subjects when 50% or more of lung function has already been irreversibly lost. This loss of lung function is detected clinically by reduced expiratory flow rates (specifically forced expiratory volume in one second or FEV1).

Despite advances in the treatment of airways disease, current therapies do not significantly alter the natural history of OCOPD with progressive loss of lung function causing respiratory failure and death. Although cessation of occupational exposure may be expected to reduce this decline in lung function, it is probable that if this is not achieved at an early stage, the loss is considerable and symptoms of worsening breathlessness likely cannot be averted.

Therefore, when considering a financial decision relating to the health of a subject, particularly an insurance-related decision, it would be advantageous to be able to identify resistant subjects and those subjects who are susceptible to developing OCOPD. For example, it would be advantageous to be able to determine if a given subject was resistant to or susceptible to developing OCOPD, and in one particularly preferred example, if a subject previously believed to be susceptible to OCOPD is determined to be resistant to developing OCOPD.

Methods to determine a subject's predisposition to and/or potential risk of developing occupational chronic obstructive pulmonary disease (OCOPD) are described in New Zealand Patent Application No. 540202, No. 541389, and PCT International Application PCT/NZ2006/000124 (published as WO2006/123954) each incorporated herein in its entirety, and are referred to collectively herein as the Respirogene™-brand pulmonary test test. Both protective polymorphisms and susceptibility polymorphisms have been identified for analysis of part of the Respirogene™-brand pulmonary test test.

Acute Coronary Syndrome

The group of cardiovascular disorders herein referred to as acute coronary syndrome (ACS) includes myocardial infarction and unstable angina. These disorders are believed to be associated with inflammation, plaque instability, and/or smoking. The Applicants believe, without wishing to be bound by any theory, that genetic risk factors are significant in susceptibility to and/or severity of ACS.

Therefore, when considering a financial decision relating to the health of a subject, particularly an insurance-related decision, it would be advantageous to be able to identify resistant subjects and those subjects who are susceptible to developing ACS. For example, it would be advantageous to be able to determine if a given subject was resistant to or susceptible to developing ACS, and in one particularly preferred example, if a subject previously believed to be susceptible to ACS is determined to be resistant to developing ACS.

Methods to determine a subject's predisposition to and/or potential risk of developing ACS are described in New Zealand Patent Application No. 543520, No. 543985, No. 549951, and PCT International Application PCT/NZ2006/000292 each incorporated herein in its entirety, and are referred to collectively herein as the Cardiogene™-brand cardiovascular test.

Lung Cancer

Lung cancer is the second most common cancer and has been attributed primarily to cigarette smoking. Other factors contributing to the development of lung cancer include occupational exposure, genetic factors, radon exposure, exposure to other aero-pollutants and possibly dietary factors [see 4]. Non-smokers are estimated to have a one in 400 risk of lung cancer (0.25%). Smoking increases this risk by approximately 40 fold, such that smokers have a one in 10 risk of lung cancer (10%) and in long-term smokers the life-time risk of lung cancer has been reported to be as high 10-15% [see 5]. Genetic factors are thought to play some part as evidenced by a weak familial tendency (among smokers) and the fact that only the minority of smokers get lung cancer. It is generally accepted that the majority of this genetic tendency comes from low penetrant high frequency polymorphisms, that is, polymorphisms which are common in the general population that in context of chronic smoking exposure contribute collectively to cancer development [see 5, 6]. Several epidemiological studies have reported that impaired lung function [see 7-11] or symptoms of obstructive lung disease [see 12] are independent risk factors for lung cancer and are possibly more relevant than smoking exposure dose.

Despite advances in the treatment of airways disease, current therapies do not significantly alter the natural history of lung cancer, which may include metastasis and progressive loss of lung function causing respiratory failure and death. Although cessation of smoking may be expected to reduce this decline in lung function, it is probable that if this is not achieved at an early stage, the loss is considerable and symptoms of worsening breathlessness likely cannot be averted. The early diagnosis of lung cancer or of a propensity to developing lung cancer enables a broader range of prophylactic or therapeutic treatments to be employed than can be employed in the treatment of late stage lung cancer. Such prophylactic or early therapeutic treatment is also more likely to be successful, achieve remission, improve quality of life, and/or increase lifespan.

Therefore, when considering a financial decision relating to the health of a subject, particularly an insurance-related decision, it would be advantageous to be able to identify resistant subjects and those subjects who are susceptible to developing lung cancer. For example, it would be advantageous to be able to determine if a given subject was resistant to or susceptible to developing lung cancer, and in one particularly preferred example, if a subject previously believed to be susceptible to lung cancer is determined to be resistant to developing lung cancer.

Methods to determine a subject's predisposition to and/or potential risk of developing lung cancer are described in New Zealand Patent Applications No. 540203, No. 541787, No. 543297, No. 550643, and PCT International Application PCT/NZ2006/000125 (published as WO2006/123955) each incorporated herein in its entirety, and are referred to collectively herein as the Bronchogene™-brand lung cancer test. Both protective polymorphisms and susceptibility polymorphisms have been identified for analysis as part of the Bronchogene™-brand lung cancer test.

Combogene

The methods of the present invention may utilise as a genetic analysis the methods of deriving a net score predictive of a subject's predisposition to a disease or condition, for example, as defined in New Zealand Patent Applications No. 540249, No. 541842, No. 551534, and PCT International Application PCT/NZ2006/000104 (published as WO2006/123943). The net score represents the balance between the combined value of the protective polymorphisms present in said subject and the combined value of the susceptibility polymorphisms present in said subject, wherein a net protective score is predictive of a reduced predisposition and/or susceptibility to said disease or condition and a net susceptibility score is predictive of an increased predisposition and/or susceptibility to said disease or condition.

Therefore, when considering a financial decision relating to the health of a subject, particularly an insurance-related decision, it would be advantageous to be able to identify resistant subjects and those subjects who are susceptible to developing one or more diseases or conditions. For example, it would be advantageous to be able to determine if a given subject was resistant to or susceptible to developing a given disease or condition, and in one particularly preferred example, if a subject previously believed to be susceptible to a given disease or condition is determined to have a net protective score and so be resistant to developing said disease or condition.

Methods to determine a subject's net scores are described in New Zealand Patent Applications No. 540249, No. 541842, No. 551534, and PCT International Application PCT/NZ2006/000104 (published as WO2006/123943) each incorporated herein in its entirety, and are referred to collectively herein as Combogene™-brand diagnostic test.

A subject's net score can be placed upon a distribution of net scores for disease sufferers and non-sufferers wherein the net scores for disease sufferers and non-sufferers are or have been determined in the same manner as the net score determined for the subject. By observing where the net score for the subject lies on this distribution, it is possible to identify those subjects having an advantageous insurance risk profile. For example, an insurance provider may set a threshold value on said distribution which separates those to whom insurance coverage will be offered from those to whom insurance coverage will not be offered. If the net score for a given subject lies within the threshold on said distribution, that subject can be identified as one to whom insurance coverage may be offered.

As previously indicated, Emphagene™-brand pulmonary test, Respirogene™-brand pulmonary test, Bronchogene™-brand lung cancer test, Cardiogene™-brand cardiovascular test and Combogene™-brand diagnostic test are preferred genetic analyses which can be applied in practising this and other embodiments of this invention.

Armed with the results of the genetic analysis (or analyses), a risk value is determined for the subject. That risk value will be a composite weighting of the data available, with a particular focus on whether the genetic data indicates an increased or reduced predisposition to the diseases tested for.

The risk value is then factored into a health-related decision to be made with respect to the subject. That decision may be made by or for the subject or by a health service provider. The decision may also be primarily financial and may be made by a health insurance provider as discussed above.

In the case of a health insurer, the decision taken will largely reflect whether the risk value favours the offering of insurance or not. As one example, should the subject be genetically tested with the results indicative of an increased predisposition to COPD when compared to other subjects of equivalent age, gender and history, the decision may be to decline coverage for COPD for that subject, or to offer coverage with reduced benefits and/or higher than usual premiums with respect to COPD.

Conversely, should the results for the subject be indicative of a reduced predisposition to COPD when compared to other subjects of equivalent age, gender and history, the decision may be to offer the subject an incentive to take an insurance policy with the insurer, or to take a policy with increased benefits/reduced premiums with respect to COPD as compared to the policy offered to an untested subject.

Similar approaches give rise to additional embodiments of the invention. These include methods of marketing insurance products by offering incentives to subjects to buy the products where the subject undertakes a genetic analysis or combination of analyses as described above (usually at the cost of the insurer marketing the product) and receives the incentive should the results show that the subject has a reduced predisposition to the diseases or the diseases tested for, or otherwise has an advantageous risk profile so far as the insurer is concerned.

While this method can be marketed to subjects amongst those already insured with the provider of the insurance product as representing reduced risk, it also has particular application to the marketing of the insurance product to customers of other competing insurance providers.

Insurance products of the type described above are also within the scope of the invention, as are computer-based systems and computer programs which are interpretive of the results of the genetic analysis or analyses performed in an insurance context.

Methods of the invention will now be described in more detail, with reference to the following non-limiting representative examples.

### EXAMPLES

### Example 1

A smoking subject wishes to obtain health insurance, but because they are a smoker, they are unable to obtain insurance coverage for pulmonary disorders, in particular, COPD.

The subject's Health Score is to be applied to an insurance-related decision. In order to derive the subject's Health Score, a determination of the subject's predisposition to COPD is performed using the Emphagene™-brand pulmonary test test. This genetic analysis reveals that the smoking subject has two protective polymorphisms.

As discussed in PCT International Application PCT/NZ2004/000103 (published as WO 2006/121351), a significant difference in frequency of COPD versus resistance was found in those with no protective polymorphisms compared to those with one or more protective genotypes (OR=2.82, P=0.0004, see PCT International Application PCT/NZ2004/000103 referred to above), such that a 2-3 fold increase in COPD in those with 0 protective genotypes was observed.

On the basis of the Emphagene™-brand pulmonary test test result—which shows the presence of two protective polymorphisms—it is determined that the smoking subject is resistant to COPD and is, in fact, at low risk of developing COPD. Despite having a lifestyle that includes a high risk activity, the Health Score derived at least in part from the genetic analysis is such that the smoking subject is offered insurance coverage for COPD.

### Example 2

A smoking subject wishes to obtain health insurance, but because they are a smoker, they are unable to obtain insurance coverage for cardiovascular disorders, in particular, ACS.

The subject's Health Score is to be applied to an insurance-related decision. In order to derive the subject's Health Score, a determination of the subject's predisposition to ACS is performed using the Cardiogene™-brand cardiovascular test. This genetic analysis reveals that the smoking subject has four protective polymorphisms, and one susceptibility polymorphism.

As disclosed in New Zealand Patent Application No. 543520, No. 543985, No. 549951, and PCT International application PCT/NZ2006/000292, a linear relationship between SNP score and frequency of ACS was determined when the polymorphisms shown in Table 1 below were analysed.

Table 1 below presents a summary of the protective and susceptibility SNPs identified in PCT/NZ2006/000292 and related applications. Selected susceptibility SNPs are identified as S1 through S13, while selected protective SNPs are identified as P1 through P16. Those shown in bold were included in panels of SNPs used to generate a SNP score as discussed below.

TABLE 1
Summary of Protective and susceptibility SNPs for ACS

| Gene | rs | Polymorphism | Genotype | SNP# | Phenotype | OR | P value |
|---|---|---|---|---|---|---|---|
| CMA1 | 1800875 | −1903 A/G | GG | S1 | susceptibility | 1.9 | 0.004 |
| TGFB1 | 1800469 | −509 C/T | CC | S2 | susceptibility | 1.5 | 0.05 |
| MMP12 | 2276109 | −82 A/G | GG | S3 | susceptibility | 3.2 | 0.05 |
| FGF2 | 1449683 | Ser52Ser 223 | CT/TT | S4 | susceptibility | 1.5 | 0.08 |
| | | C/T | (CC) | | (protective) | | |
| IL4RA | 1801275 | Q576R A/G | GG | S5 | susceptibility | 2.7 | 0.02 |
| | | | AA | | protective | 0.47 | 0.05 |
| LTA | 1041981 | Thr26Asn A/C | CC | P1 | protective | 0.66 | 0.04 |
| HSP70 | 2227956 | Hom T2437C | CC/CT | P2 | protective | 0.66 | 0.04 |
| | | | (TT) | | (susceptibility) | | |
| TLR4 | 4986790 | ¹Asp299Gly | AG/GG | P3 | protective | 0.54 | 0.07 |
| | | A/G | (AA) | | (susceptibility) | | |
| TLR4 | 4986791 | ²Thr399Ile | CT/TT | P3.1 | protective | 0.54 | 0.06 |
| | | C/T | (CC) | | (susceptibility) | | |
| IFNG | 2430561 | 874 A/T | TT | P4 | protective | 0.57 | 0.03 |
| NFKBIL1 | 2071592 | −63 T/A | AA | P11 | protective | 0.73 | 0.10 |
| PDGFRA | — | −1630 I/D, | I/Del, | P5 | protective | 0.68 | 0.05 |
| | | (AACTT/Del) | Del/Del | | (susceptibility) | | |
| | | | (II) | | | | |
| IL4 | 2243250 | −589 C/T | CT/TT | P6 | protective | 0.68 | 0.11 |
| | | | (CC) | | (susceptibility) | | |
| MMP1 | 1799750 | −1607 1G/2G | Del. Del | S6 | susceptibility | 1.4 | 0.12 |
| | | (Del/G) | (ie 1G1G) | | | | |
| PDGFA | — | 12 IN5 C/T | TT | S7 | susceptibility | 1.4 | 0.14 |
| GCLM | — | −588 C/T | CT/TT | S8 | susceptibility | 1.4 | 0.13 |
| | | | (CC) | | (protective) | | |
| OR13G1 | 1151640 | Ile132Val | AA | S9 | susceptibility | 1.4 | 0.14 |
| | | A/G | | | | | |
| IL-10 | 1800896 | −1084 A/G | GG | P12 | protective | 0.74 | 0.19 |
| | | (−1082) | | | | | |
| α1-AT S | 17580 | Glu288Val | AT/TT | S10 | susceptibility | 1.5 | 0.16 |
| allele | | A/T (M/S) | (MS/SS) | | | | |
| ICAM1 | 5498 | K469E A/G | AA | P7 | protective | 0.70 | 0.09 |
| BAT1 | 2239527 | −23 C/G | GG | P8 | protective | 0.71 | 0.09 |
| NOS3 | 1799983 | Glu298Asp | GG | P9 | protective | 0.72 | 0.09 |
| | | G/T | | | | | |
| SOD3 | 1799895 | Arg213Gly | CG/GG | P10 | protective | 0.23 | 0.13 |
| | | C/G | | | | | |
| PAI-1 | — | −668 4G/5G | 5G5G | P13 | protective | 0.72 | 0.19 |
| MIP1A | 1719134 | +459 C/T | CT/TT | S11 | susceptibility | 1.31 | 0.18 |
| | | Intron 1 | | | | | |
| MMP7 | 17880821 | −181 A/G | GG | P14 | protective | 0.70 | 0.19 |
| Cathepsin | | Asn 125Ser | AG/GG | P15 | protective | 0.58 | 0.12 |
| G | | | AA | | (susceptibility) | | |
| CX3CR1 | 3732379 | I249V | TT | S12 | susceptibility | 1.5 | 0.15 |
| NOD2 | 2066845 | Gly 881 Arg | CC/CG | S13 | susceptibility | 2.1 | 0.15 |
| | | G/C | | | | | |
| TIMP1 | 4898 | 372 T/C | TT | P16 | protective | 0.27 | 0.00005 |
| | | | CC | | susceptibility | 1.4 | 0.06 |

S3 above is in linkage disequilibrium (LD) with S6, P1 above is in LD with P11 and P3 above is in LD with P3.1. Hence, these SNPs were not used together in a panel when deriving the SNP score.

Table 2 below shows the distribution of ACS patients and smoking controls with reference to a SNP score as disclosed in PCT/NZ2006/000292. The SNP score for each individual was determined in a combined analysis of an 11 SNP panel consisting of SNPs S1-S5 and P1-P6 as shown above in Table 1. Each susceptibility SNP was assigned a value of +1, and each protective SNP was assigned a value of −1. Values were added to derive a net SNP score.

TABLE 2
Distribution of ACS sufferers and smoking controls according to SNP score

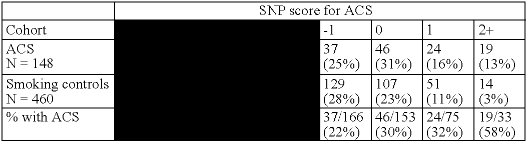

On the basis of this pre-existing analysis, those SNP scores with shading (SNPs scores of −2 and below) are viewed by the insurance provider as representing low to average risk of ACS. At this threshold, 15% of ACS subjects are found and 35% of control smokers. On the linear relationship between ACS frequency and SNP score, this equates to about a 13% risk of ACS. Subjects with SNP scores of −2 and below are identified by the insurer as those to whom insurance coverage can be offered.

The smoking subject has a SNP score of −3. On the basis of the Cardiogene™-brand cardiovascular test result, it is determined that the smoking subject is resistant to ACS and is, in fact, at low risk of developing ACS. Despite having a lifestyle that includes a high risk activity, the Health Score derived at least in part from the genetic analysis is such that the smoking subject is offered insurance coverage for ACS by the insurance provider.

### Example 3

A smoking subject wishes to obtain health insurance, but because they are a smoker and work in an industry associated with a high level of exposure to aeropollutants, they are unable to obtain insurance coverage for pulmonary disorders, in particular, OCOPD.

The subject's Health Score is to be applied to an insurance-related decision. In order to derive the subject's Health Score, a determination of the subject's predisposition to OCOPD is performed using the Respirogene™-brand pulmonary test test. This genetic analysis reveals that the smoking subject has one protective polymorphisms and three susceptibility polymorphism.

As discussed in New Zealand Patent Application No. 540202/541389, and PCT

International application PCT/NZ2006/000124, a linear relationship between SNP score and frequency of OCOPD was determined.

Table 3 below shows the distribution of OCOPD patients and smoking controls with reference to a SNP score as disclosed in PCT/NZ2006/000124. The SNP score for each individual was determined in a combined analysis of protective and susceptibility polymorphisms. Each susceptibility SNP was assigned a value of −1, and each protective SNP was assigned a value of +1. Values were added to derive a net SNP score.

TABLE 3
Distribution of OCOPD sufferers and smoking
controls according to SNP score

| | SNP score for OCOPD | | | | | |
|---|---|---|---|---|---|---|
| | −2 | −1 | 0 | 1 | 2 | 3 |
| OCOPD n = 124 | 8 | 28 | 33 | 39 | 11 | 5 |
| Exposed Resistant n = 101 | 2 | 11 | 23 | 27 | 23 | 15 |
| % COPD | 80% | 72% | 59% | 59% | 32% | 25% |

On the basis of this pre-existing analysis, SNP scores below 3 are viewed by the insurance provider as representing unacceptably high risk of OCOPD. Below this threshold, more than 25% of subjects have OCOPD. Subjects with SNP scores below 3 are identified by the insurer as those to whom insurance coverage can not or should not be offered.

The smoking and occupationally-exposed subject has a SNP score of −2. On the basis of the Respirogene™-brand pulmonary test result, it is determined that the smoking and occupationally-exposed subject is predisposed to OCOPD and is, in fact, at very high risk of developing OCOPD. The Health Score derived at least in part from the genetic analysis is such that the smoking and occupationally-exposed subject is not offered insurance coverage for OCOPD by the insurance provider.

### Example 4

Two smoking subjects wish to obtain health insurance, but because they are heavy smokers they are unable to obtain insurance coverage for lung cancer.

The subjects' Health Scores are to be applied to an insurance-related decision. In order to derive the subjects' Health Scores, a determination of the subjects' predispositions to lung cancer are performed using the Bronchogene™-brand lung cancer test. This genetic analysis reveals that the first smoking subject has four protective polymorphisms, while the second has two protective polymorphisms.

As discussed in New Zealand Patent Application Nos 540203/541787/543297 and 550643 and PCT International application PCT/NZ2006/000125, a linear relationship between SNP score and frequency of lung cancer was determined.

Table 4 below shows the distribution of lung cancer patients and smoking controls with reference to the number of protective polymorphisms CYP1A1 GG/AG, OGG1 GG, CCND1 GG, NOS3 298 TT, IL-8 AA, XRCC1 AA, Cox 2-765 CC/CG as disclosed in PCT/NZ2006/000125.

TABLE 4
Combined frequencies of the presence or absence of protective
polymorphisms in Lung cancer subjects and resistant smokers

| | Number of protective polymorphisms | | | |
|---|---|---|---|---|
| Cohorts | 0 | 1 | ≧2 | Total |
| Lung Cancer | 45 (40%) | 50 (43%) | 19 (17%) | 114 |
| Resistant smokers | 47 (23%) | 79 (40%) | 74 (37%) | 200 |
| % of smokers with Lung | 45/47 | 50/129 | 19/93 | |
| cancer | (49%) | (39%) | (20%) | |

| Comparison | Odd's ratio | 95% CI | χ2 | P value |
|---|---|---|---|---|
| 0 vs 1 vs 2+, Resist vs Lung | — | — | 16.8 | 0.0002 |
| cancer | | | | |
| 2+ vs 0-1, Resist vs Lung cancer | 2.94 | 1.6-5.4 | 13.44 | 0.0002 |
| 0 vs 2+, Lung cancer vs Resist | 2.12 | 1.3-3.6 | 8.2 | 0.004 |

On the basis of this pre-existing analysis, subjects with fewer than 2 protective polymorphisms are viewed by the insurance provider as presenting an unacceptably high risk of lung cancer. Below this threshold, more than 20% of subjects have lung cancer. Accordingly, subjects with fewer than 2 protective polymorphisms are identified by the insurer as those to whom insurance coverage can not or should not be offered.

The first subject has four protective polymorphisms. On the basis of the Bronchogene™-brand pulmonary test result, it is determined that this subject is not predisposed to lung cancer and is, in fact, at low risk of developing lung cancer. The Health Score derived at least in part from the genetic analysis is such that the first subject is offered insurance coverage for lung cancer by the insurance provider.

The second subject has two protective polymorphisms. On the basis of the Bronchogene™-brand pulmonary test result, it is determined that this subject is perhaps at moderate risk of developing lung cancer. The Health Score derived at least in part from the genetic analysis is such that the smoking subject is offered insurance coverage for lung cancer by the insurance provider, but at a coverage/premium balance that reflects their moderate risk profile.

### Example 5

An insurance provider wishes to identify those smoking subjects who have a reduced genetic predisposition to diseases associated with smoking, and are thus at a sufficiently low risk to consider as potential insurees. The insurance provider is aware of studies reporting that 50% of smokers die from their smoking and 25% die before aged 65 years of age. Of those that die prematurely, 80% of deaths are attributed to coronary artery disease, lung cancer and COPD. The insurance provider recognises that a smoker's susceptibility to these diseases are in part due to genetic predisposition, and that if this predisposition could be identified, smokers could be identified at a young age and through genotyping determine who are low, medium and high risk for these conditions.

As described in the Applicant's New Zealand Patent Application accompanied by a provisional specification filed 7 Dec. 2006 entitled “Methods of Analysis of Polymorphisms and Uses thereof”, the Applicants genotyped 144 volunteer smokers using each of the Emphagene™-brand pulmonary test, the Bronchogene™-brand lung cancer test, and the Cardiogene™-brand cardiovascular test to determine the distribution of those smokers that were at high and low risk across all 3 tests. Smokers had a minimum 15 pack year history, and were not diagnosed as ACS, lung cancer or COPD sufferers.

A SNP score for each of the tests was determined for each individual in a combined analysis of protective and susceptibility polymorphisms associated with each disease. Each susceptibility SNP was assigned a value of +1, and each protective SNP was assigned a value of −1. Values were added to derive a net SNP score for each test.

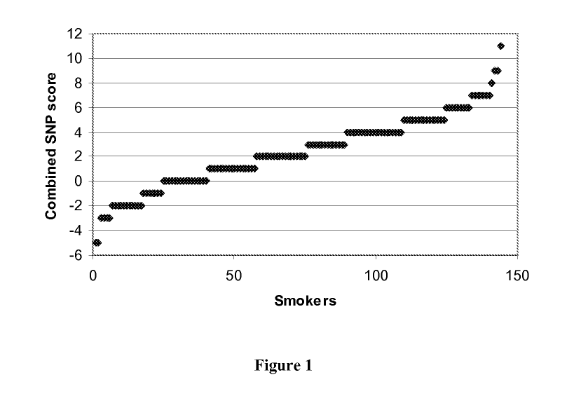

The distribution was examined in terms of the frequency of smokers in respect of each of the 3 tests (Table 5) and in terms of a combined SNP score from adding the SNP scores for each of the three tests (FIG. 1).

Low risk smokers (combined score −5 to 0) made up 28% (40/144) and high risk smokers (combined score of 5 to 11) made up 24% (36/144) (FIG. 1). As shown below in Table 5, when smokers were divided in to low and high risk for each test and then compared across all 3 tests, for low risk smokers 37% were low risk for all 3 tests, while 16% were low for 2 or 3 tests. For high risk smokers, 20% are high risk for 2+ tests while 36% are not high risk for any of the 3 tests. In Table 5 below, “3 tests” represents each of the Emphagene™-brand pulmonary test, the Bronchogene™-brand lung cancer test, and the Cardiogene™-brand cardiovascular test, while “2 tests” and “1 test” represent two or one of these tests, respectively.

TABLE 5
Frequency of smokers for each test

| Risk group | 3 tests | 2 tests | 1 test | No tests |
|---|---|---|---|---|
| Low risk | 2 | 21 | 68 | 53 |
| (n = 144) | (1.4%) | (14.6%) | (47.2%) | (36.8%) |
| High risk | 0 | 29 | 63 | 52 |
| (n = 144) | (0%) | (20.1%) | (43.8%) | (36.1%) |

When the SNP scores for each of the three tests were added to together, a combined SNP score was derived. A normal distribution of combined score amongst the smokers was observed (see FIG. 1).

The insurance provider recognises that this normal distribution of combined scores provides a powerful overall tool for risk assessment. Potential insurees are offered each of the Emphagene™-brand pulmonary test, the Bronchogene™-brand lung cancer test, and the Cardiogene™-brand cardiovascular test, and the results are analysed to determine combined SNP scores for each individual. Those individuals with low risk in 2 or 3 of the tests are offered insurance at a coverage/premium balance commensurate with their risk.

### INDUSTRIAL APPLICATION

The present invention is directed to methods and systems for assessing a subject's health risk and applying that assessment to a health-related decision, in particular a financial decision. The methods and systems involve the analysis of polymorphisms associated with increased or decreased risk of developing a disease, or the analysis of results obtained from such an analysis, and the use of that analysis in determining a subject's health risk. Methods and systems for determining the availability of insurance to a subject utilising an assessment of a subject's health risk are also provided, as are insurance products made available to selected subjects undergoing such assessments.

### PUBLICATIONS

1. Leigh et al. Chest 2002, 121, 264.
2. Hnizdo et al. Am J. Epidemiol. 2002, 156, 738.
3. Sandford A J, et al., 1999. Z and S mutations of the α1-antitrypsin gene and the risk of chronic obstructive pulmonary disease. Am J Respir Cell Mol Biol. 20; 287-291.
4. Alberg A J, Samet J M. Epidemiology of lung cancer. Chest 2003, 123, 21 s-49s.
5. Schwartz AG. Genetic predisposition to lung cancer. Chest 2004, 125, 86s-89s.
6. Wu X, Zhao H, Suk R, Christiani D C. Genetic susceptibility to tobacco-related cancer. Oncogene 2004, 23, 6500-6523.
7. Anthonisen N R. Prognosis in COPD: results from multi-center clinical trials. Am Rev Respir Dis 1989, 140, s95-s99.
8. Skillrud D M, et al. Higher risk of lung cancer in COPD: a prospective matched controlled study. Ann Int Med 1986, 105, 503-507.
9. Tockman M S, et al. Airways obstruction and the risk for lung cancer. Ann Int Med 1987, 106, 512-518.
10. Kuller L H, et al. Relation of forced expiratory volume in one second to lung cancer mortality in the MRFIT. Am J Epidmiol 1190, 132, 265-274.
11. Nomura a, et al. Prospective study of pulmonary function and lung cancer. Am Rev Respir Dis 1991, 144, 307-311.
12. Mayne S T, et al. Previous lung disease and risk of lung cancer among men and women nonsmokers. Am J Epidemiol 1999, 149, 13-20.

All patents, publications, scientific articles, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents.

The specific methods and compositions described herein are representative of various embodiments or preferred embodiments and are exemplary only and not intended as limitations on the scope of the invention. Other objects, aspects, examples and embodiments will occur to those skilled in the art upon consideration of this specification, and are encompassed within the spirit of the invention as defined by the scope of the claims. It will be readily apparent to one skilled in the art that varying substitutions and modifications can be made to the invention disclosed herein without departing from the scope and spirit of the invention. The invention illustratively described herein suitably can be practiced in the absence of any element or elements, or limitation or limitations, which is not specifically disclosed herein as essential. Thus, for example, in each instance herein, in embodiments or examples of the present invention, any of the terms “comprising”, “consisting essentially of”, and “consisting of” may be replaced with either of the other two terms in the specification, thus indicating additional examples, having different scope, of various alternative embodiments of the invention. Also, the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also that as used herein and in the appended claims, the singular forms “a,” “an,” and “the” include plural reference unless the context clearly dictates otherwise. Thus, for example, a reference to “a host cell” includes a plurality (for example, a culture or population) of such host cells, and so forth. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention.

1. A method of deriving a Health Score for a subject with respect to their predisposition to two or more diseases or conditions, at least one of which is selected from COPD, emphysema, OCOPD, lung cancer or ACS, said method comprising the steps of:
receiving data predictive of the predisposition of said subject to at least two diseases or conditions, at least one of which is selected from COPD, emphysema, OCOPD, lung cancer or ACS, said data consisting of or including the result of at least one genetic analysis selected from the Emphagene™-brand pulmonary test, the Respirogene™-brand pulmonary test, the Bronchogene™-brand lung cancer test, the Cardiogene™-brand cardiovascular test, or the Combogene™-brand diagnostic test, determining a Health Score for said subject based upon that data.

2. The method according to claim 1 wherein said data from said at least one genetic analysis is combined with data indicative of a predisposition on the part of said subject to one or more diseases or conditions based upon the family, occupational, environmental or lifestyle history of said subject.

3. The method according to claim 1 wherein once derived, said Health Score is applied to a financial decision.

4. The method according to claim 3 wherein said financial decision is an insurance-related decision.

5. A method of balancing a health risk and a financial risk with respect to a subject, said method comprising the steps of:
receiving data predictive of the predisposition of a subject to one or more diseases or conditions, said data consisting of or including the results of at least one genetic analysis,
determining a risk value for the subject based upon that data,
factoring that risk value into a health-related decision to be made with respect to that subject.

6. The method according to claim 5 wherein said health-related decision is an insurance-related decision.

7. The method according to claim 5 wherein said at least one genetic analysis is selected from amongst genetic tests which predict the predisposition of the subject to one or more diseases selected from cancer, coronary artery disease, COPD, emphysema and OCOPD.

8. The method according to claim 7 wherein the cancer is lung cancer.

9. The method according to claim 7 wherein the coronary artery disease is ACS.

10. The method according to claim 7 wherein said tests are selected from the Emphagene™-brand pulmonary test, the Respirogene™-brand pulmonary test, the Bronchogene™-brand lung cancer test, the Cardiogene™-brand cardiovascular test, or the Combogene™-brand diagnostic test.

11. The method according to claim 5 wherein said at least one genetic analysis is targeted at predicting predisposition to said disease or condition and an attendant risk value which is increased compared to other subjects of equivalent age, gender and history through detection of the presence of absence of one or more susceptibility polymorphisms.

12. The method according to claim 11 wherein an increased risk value is factored into an insurance-related decision selected from denial of insurance coverage to the subject and the offering of insurance coverage to said subject with benefits and premiums which reflect the increased risk value.

13. The method according to claim 5 wherein said at least one genetic analysis is targeted at predicting predisposition to said disease or condition and an attendant risk value which is reduced compared with other subjects of equivalent age, gender and history through detection of the presence or absence of one of more protective polymorphisms.

14. The method according to claim 13 wherein a reduced risk value is factored into an insurance-related decision selected from offering said subject insurance coverage with additional benefits, reduced premiums, or both.

15. The method according to claim 5 wherein said subject is an existing insured.

16. The method according to claim 5 wherein said subject is a non-insured.

17. The method according to claim 16 wherein said non-insured is a never insured.

18. The method according to claim 15 wherein said non-insured can be a subject previously declined insurance and said additional benefits offered to such a subject with a reduced risk value can be the offering of insurance coverage.

19. The method according to claim 15 wherein said existing insured can be a subject with exclusions to their insurance coverage for specific diseases or conditions and said additional benefits can be the offering of insurance coverage without said exclusions.

20. A method of identifying a subject to be offered health insurance with respect to at least one disease or condition, said method comprising the steps of:
receiving data predictive of the predisposition of a subject to one or more diseases or conditions, said data consisting of/or including the result of at least one genetic analysis which shows the presence of at least one polymorphism protective against at least one disease or condition; and
offering said subject health insurance with coverage of said at least one disease or condition.

21-95. (canceled)
